(19) United States
(12) Patent Application Publication
(10) Pub. No.: US 2023/0324932 A1
(43) Pub. Date: Oct. 12, 2023

(54) Smart perfume bottle for mixing perfumes by smell and concentration based on an artificial intelligence

(71) Applicant: Abdulilah M. Mayet, Jeddah (SA)

(72) Inventor: Abdulilah M. Mayet, Jeddah (SA)

(21) Appl. No.: 18/086,936

(22) Filed: Dec. 22, 2022

Related U.S. Application Data
(60) Provisional application No. 63/362,600, filed on Apr. 7, 2022.

(51) Int. Cl. G05D 11/13; A45D 34/04

(52) U.S. Cl. CPC G05D 11/13; A45D 34/04; A45D 2034/005

(57) ABSTRACT

The present invention generally relates to a system, apparatus, and method for blending a plurality of perfumes stored in a mixer comprising a plurality of differently scented fragrances in separate bottles or cartridges that are actuated based on instructions received using a coupled mobile device that utilizes an artificial intelligence (AI) algorithm for determining the fragrance mixture preferences and different scenarios that can be related to various perfume scents. In embodiments, the mixing device or apparatus may further comprise batteries that can be either replaced or charged. Further disclosed is a method for preparing perfumes based on already saved formulations generated by an AI. Techniques are also disclosed to provide dispensing of blended fragrances at a stipulated time and of a particular formulation. Some embodiments may further disclose a touch-based dispensing feature on the mixer.

### CROSS-REFERENCE DATA

The present application claims a priority date benefit from my co-pending U.S. Provisional Patent Application No. 60/608,956 with the same title filed Apr. 7, 2022 and incorporated herein by reference in its entirety.

### FIELD OF INVENTION

The present invention generally relates to a system, apparatus, and method for blending a plurality of perfumes stored in a mixer comprising a plurality of differently scented fragrances in separate bottles or cartridges that are actuated based on instructions received using a mobile device operatively connected thereto that utilizes an artificial intelligence (AI) algorithm for determining the fragrance mixture preferences and different scenarios that can be related to various perfume scents.

### BACKGROUND

A person's fragrance is part of their self-expression, and the right perfume or cologne can be just as important as the right clothes or the right hairstyle. In order to produce a wide range of fragrances found on the market today, industrial fragrance manufacturers must make use of high-quality perfume mixers.

High-quality colognes and perfumes are produced using a wide range of ingredients. Most of the time, alcohol or petrochemicals are the base ingredient of the product, while additives such as plant oils, spices, fruits, and much more are used to give the product its unique scent.

While choosing the right ingredients may be the most important part of producing a perfume or a cologne, effectively mixing those ingredients together is an essential next step. In order to mix all of these ingredients into a well-blended product, fragrance manufacturers must make use of high-quality perfume production equipment, such as electric fragrance mixers. This makes choosing the right industrial electric mixer an important decision for any company looking to begin mixing perfumes or colognes.

However, great mixers are not easily available as small portable devices that can be used at home to achieve variety of fragrance by mixing several fragrances. The prior art does not disclose a feature of providing artificial intelligence-based mixing of perfumes before dispensing based on a mobile device i.e. user device based according to his preference such as mood.

For example, US20220080438 discloses an apparatus for creating custom perfumes is disclosed. The apparatus may comprise a body that may hold perfume refills and a mixing chamber connected to the perfume refills via a plurality of valves. The apparatus may be controlled by a microcontroller. The apparatus may receive custom formulas for creating custom perfumes from users. The apparatus may comprise a body that may allow one or more perfume refills to be inserted into the body via one or more refill slots. The apparatus may hold a plurality of perfume refills having different fragrances at a time. Furthermore, the apparatus may allow users to communicate with the apparatus and provide instructions to it via a user interface.

In another example, US20120018528 discloses a method of dispensing at least one test scent within a system that includes a server configured to exchange data with a plurality of interactive scent-formulation terminals, each interactive terminal including a plurality of odorous substances, serving when combined in various proportions to create a plurality of scents; dispenser means for dispensing a selection of the odorous substances out from the terminal. Exemplary embodiments of the invention provide a method of dispensing at least one test scent within a system comprising a server configured to exchange data with a plurality of interactive scent-formulation terminals, each interactive terminal comprising: a plurality of odorous substances, serving when combined in various proportions, to create a plurality of scents; dispenser means for dispensing a selection of the odorous substances out from the terminal; a network interface enabling the terminal to communicate with the server; and a user interface; in which method the server automatically sends data to at least one terminal, the data describing at least one formulation enabling the terminal to dispense a test scent while leaving the user of the terminal free to select the moment at which the test scent is dispensed.

However, all discussed prior art does not disclose a system, apparatus and method for blending a plurality of perfumes stored in a mixer comprising a plurality of differently scented fragrances in separate bottles or cartridges that are actuated based on instructions received using a coupled mobile device that utilizes an artificial intelligence (AI) algorithm for determining the fragrance mixture preferences and different scenarios that can be related to various perfume scents. It is, therefore, an object of the current invention to overcome the technical limitation identified in the prior art.

### SUMMARY OF THE INVENTION

The following summary is an explanation of some of the general inventive steps for the device, method, and construction in the description. This summary is not an extensive overview of the invention and does not intend to limit the scope beyond what is described and claimed as a summary.

The present invention generally relates to a system, apparatus, and method for blending a plurality of perfumes stored in a mixer comprising a plurality of differently scented fragrances in separate bottles or cartridges that are actuated based on instructions received using a coupled mobile device that utilizes an artificial intelligence (AI) algorithm for determining the fragrance mixture preferences and different scenarios that can be related to various perfume scents.

According to one embodiment, the mixing device or apparatus may further comprise batteries that can be either replaced or charged. Further, references disclose a method for preparing perfumes based on already saved formulations generated by an AI.

According to another embodiment, techniques disclosed provide for dispensing blended fragrances at a stipulated time and of a particular formulation. Some embodiments may further disclose a touch-based dispensing feature on the mixer.

According to yet another embodiment, disclosed is a smart perfume bottle with multiple perfume bottles to mix the perfume according to the demanded smell and concentration.

According to a further yet embodiment, the mixing process is controlled by an artificial intelligence-based smart phone app which helps the user to predict the demanded smell according to his preference, mood, and the day or night time.

According to yet another embodiment, the mixer contains more than 10 bottles containing distinct yet complementing fragrances.

### BRIEF DESCRIPTION OF THE FIGURES

FIG. 1 of the diagrams illustrates an exemplary mixing device according to one embodiment.

FIG. 2 of the diagrams illustrates an exemplary mixing system according to one embodiment.

### DETAILED DESCRIPTION OF THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

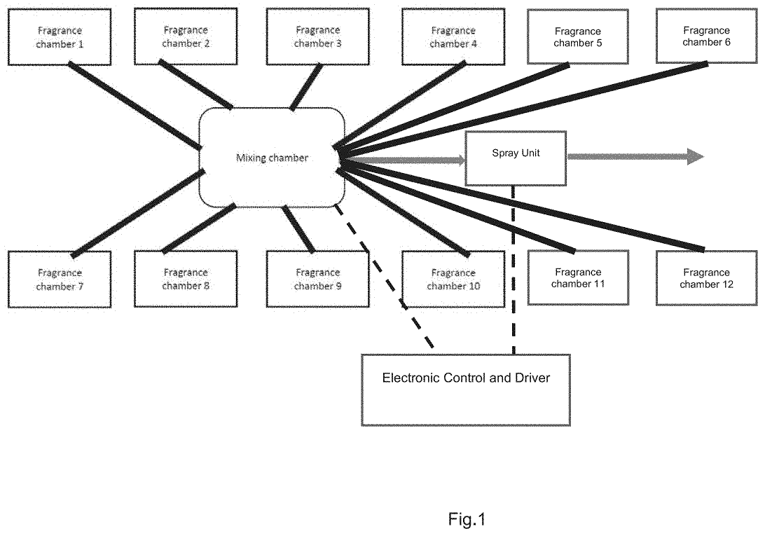

In the first embodiment, according to FIG. 1 of the diagrams, illustrated is an exemplary mixing device according to one embodiment. FIG. 1 shows a plurality of mixing chambers, preferably at least ten, but a smaller or higher number of chambers may also work in accordance with this disclosure. The fragrance chambers each contain a distinct scented ingredient and are linked to a mixing chamber. The mixing chamber has an outlet or spraying mechanism, which may be touch activated.

The shown device is an electronically controlled apparatus mixing different fragrances according to the user's preference. The mixing process is based on an artificial intelligence-oriented operation based on a smartphone app or similar. An AI-based smartphone app runs the device to create the perfume mixture according to the user's mood, day or night, for work for an evening out, or dozens of different options. A drive mechanism is present in the shown device to perform the mixing of the fragrances.

After mixing the fragrances, the device may further comprise an automated spray operation starting with a touch activation sensor. While an exploded view has been shown for demonstration purposes to understand the invention, in practice, all device components are confined inside a handy single housing. The housing includes more than ten bottles, electrical valves, check valves, pumps, automatic sprayers, an electronics board, LEDs, touch switches, a Bluetooth communication part wireless charger, and a rechargeable battery.

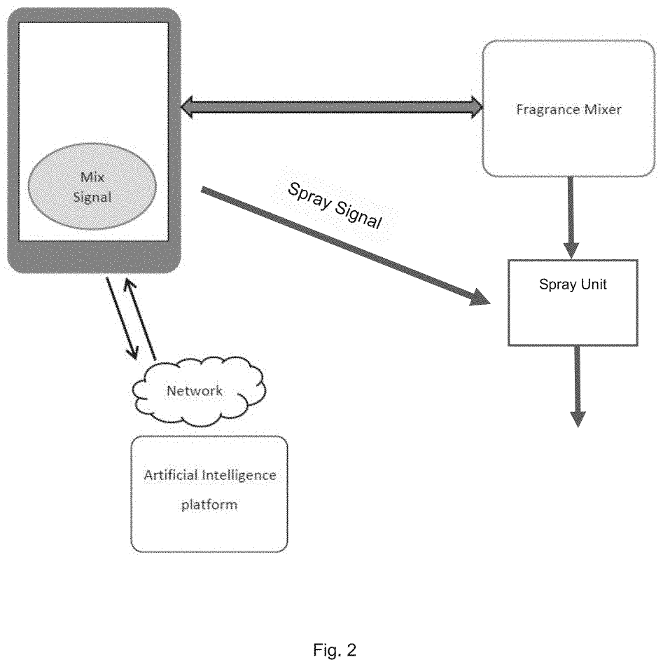

Referring to the FIG. 2 of the diagrams, it is illustrated an exemplary mixing system according to one embodiment. FIG. 2 shows a mobile device, preferably a smartphone, capable of transmitting a mix signal to the fragrance mixer, the device exemplified by FIG. 1 above. A dedicated AI-based application is configured on the smartphone to control the operation of the fragrance mixer device through Bluetooth, Wi-Fi, or some other networked means. The user identifies their preferences with AI assistance.

It is anticipated that perfume selection varies widely according to the user's preferences, his/her mood, day or night, for work for an evening out, feminine, masculine, or dozens of different options. The device is configured to perform the AI processing locally or via a remote intelligence platform and subsequently send the mixture signal command to the fragrance mixture, including the desired volume of the mixture, the spray pressure, perfume volume, period, and the number of sprays.

According to one embodiment, the fragrance mixer device comprises an outer housing, including more than ten fragrance bottles inside thereof controlled by electrical valves and check valves. High-precision pumps will pump the desired fragrance with the desired quantity into a disposable reservoir for mixing the fragrances. The device is now ready for spraying the perfume on the user. Thereafter, the device may be actuated by preset spraying settings by touching the touch switch and directing the nozzle toward the desired location.

It is anticipated that the device stands on top of a wireless charging base for an easy charging process and may contain more than one disposable mixing compartment for different lines of mixtures. It is preferable that fragrance selections ship in sealed non-refillable cartridges for quality control purposes. The cartridge change is an easy process and is servable by the user.

Aspects of the present invention are described herein with reference to flowchart illustrations and/or block diagrams of methods, apparatus (systems), and computer program products according to embodiments of the invention. It will be understood that each block of the flowchart illustrations and/or block diagrams and combinations of blocks in the flowchart illustrations and/or block diagrams can be implemented by computer-readable program instructions.

Although a preferred embodiment of the present invention has been described for illustrative purposes, those skilled in the art will appreciate that various modifications, additions, and substitutions are possible without departing from the scope and spirit of the invention as disclosed in the accompanying claims. Such alterations are herewith anticipated.

### INDUSTRIAL APPLICATION

The invention is applicable in the beauty and fashion industry and, specifically, in the manufacture of fragrance mixing devices.

What is claimed is:

1. Ascent dispensing device, comprising:
a plurality of chambers, each containing a differently scented ingredient;
a driving system configured to separately cause each of the plurality of chambers to dispense a quantity of the respective scented ingredient;
a delivery system configured to transport any dispensed quantities from the scent chambers to a common receiving area for dispensing onto a single medium;
a mobile control device configured with a suitably trained machine learning algorithm to drive the driving system to dispense a quantity of said respective scented ingredient;

2. The scent dispensing device of claim 1, wherein the device comprises at least ten scented ingredient chambers.

3. The scent dispensing device of claim 1, wherein the driving system includes an electric motor that drives a gearhead that pushes a piston to dispense a quantity of a scent in the respective chambers.

4. The scent dispensing device of claim 1, further comprising a networked receiver coupled to said mobile driving device.

5. The scent dispensing device of claim 1, wherein said plurality of chambers comprise removable cartridges.

6. The scent dispensing device of claim 1, wherein said removable cartridges are non-refillable.

7. The scent dispensing device of claim 1, wherein said mobile control device is coupled to an external intelligence platform.

8. The scent dispensing device of claim 1, wherein the suitably trained machine learning algorithm determines fragrance mixtures based at least in part on preferences, mood, event, gender, time, season, or any such.

9. The scent dispensing device of claim 1, wherein the coupling with the mixer device is via a wired or wireless connection means.

10. The scent dispensing device of claim 9, wherein the connection means is one or more of Bluetooth, Wi-Fi, or an electromagnetic signal.

11. The scent dispensing device of claim 1, wherein said plurality of mixing chambers comprise disposable cartridges.

12. The scent dispensing device of claim 1, further comprising a wireless charging means.

13. The scent dispensing device of claim 1, further comprising more than 10 reservoirs for fragrance disposable cartridges.
